(19) United States
(12) Patent Application Publication
(10) Pub. No.: US 2022/0230786 A1
(43) Pub. Date: Jul. 21, 2022

(54) MANUFACTURING METHOD AND MANUFACTURING DEVICE FOR WIRE HARNESS

(71) Applicants: AutoNetworks Technologies, Ltd., Mie (JP); Sumitomo Wiring Systems, Ltd., Mie (JP); SUMITOMO ELECTRIC INDUSTRIES, LTD., Osaka (JP)

(72) Inventor: Shigeto KATO, Mie (JP)

(73) Assignees: AutoNetworks Technologies, Ltd., Mie (JP); Sumitomo Wiring Systems, Ltd., Mie (JP); SUMITOMO ELECTRIC INDUSTRIES, LTD., Osaka (JP)

(21) Appl. No.: 17/614,669

(22) PCT Filed: Mar. 23, 2020
(86) PCT No.: PCT/JP2020/012634

§ 371 Date: Nov. 29, 2021

(30) Foreign Application Priority Data
Jun. 17, 2019 (JP) 2019-111808

(51) Int. Cl. H01B 13/012

(52) U.S. Cl. CPC H01B 13/01209

(57) ABSTRACT

An object of the present invention is to provide a technique with which at least part of an assembling process of a wire harness can be automated with a simple device. A method for manufacturing a wire is a method for manufacturing a wire harness by bundling a wiring body of the wire harness, the wiring body being in a state before a branch is formed. The method includes a process of moving the terminal portion in a predetermined draw-out direction by a holding portion moving portion of the size-measurement mechanism in a state where one of terminal portions is held by a terminal holding portion of a size measurement mechanism, and measuring a length from the one terminal portion to the position of one branch point.

### TECHNICAL FIELD

The present disclosure relates to a manufacturing method and a manufacturing device for a wire harness.

### BACKGROUND ART

A manufacturing process for a wire harness can be largely divided into a circuit formation process and an assembly process, for example. The circuit formation process is a process for forming a circuit by respectively connecting end portions of a plurality of wires of predetermined lengths to predetermined connectors, for example. The assembly process is a process for assembling a wiring body that has been provided with a circuit into a shape that can be mounted in a vehicle or the like. In the assembly process, a plurality of wires are bundled together, branches are formed at the wiring body, and exterior members are attached, for example.

Patent Document 1 discloses a technique with which automation of an assembly process within a manufacturing process for a wire harness is achieved.

### CITATION LIST

### Patent Document

Patent Document 1: JP 2018-10796A

### SUMMARY OF INVENTION

### Technical Problem

In Patent Document 1, the assembly process is automated using a vertical articulated robot and the like. It is desired that automation of the assembly process is realized with a simpler device.

In view of this, an object is to provide a technique with which at least part of a process for assembling a wire harness can be automated with a simple device.

### Solution to Problem

A method for manufacturing a wire harness according to the present disclosure is a method for manufacturing a wire harness by bundling a wiring body for the wire harness, the wiring body being in a state before a branch is formed, the method including: (a) a process of arranging a plurality of terminal portions of the wiring body side by side in a terminal holding jig; (b) a process of transferring, out of the plurality of terminal portions, one terminal portion branching from one branch point, from the terminal holding jig to a terminal holding portion of a length adjusting mechanism; (c) a process of moving the terminal holding portion in a predetermined draw-out direction with a holding portion moving portion of the length adjusting mechanism, and measuring a length from the one terminal portion to a position of the one branch point; and (d) a process of bundling the wires that extend from all the terminal portions branching from the one branch point at the one branch point, in a state in which the processes (b) and (c) have been performed for all the terminal portions branching from the one branch point.

### Advantageous Effects of Invention

According to the present disclosure, at least part of a process for assembling a wire harness can be automated with a simple device.

### BRIEF DESCRIPTION OF DRAWINGS

FIG. 1 is a plan view showing a wire harness.

FIG. 2 is a perspective view showing a manufacturing device for a wire harness according to an embodiment.

FIG. 3 is an illustrative diagram showing an example of a transfer task.

FIG. 4 is an illustrative diagram showing an example of a length measurement task.

FIG. 5 is an illustrative diagram showing an example of a partial bundling task.

FIG. 6 is an illustrative diagram showing an example of a partial bundling task.

FIG. 7 is an illustrative diagram showing an example of a temporary holding task.

FIG. 8 is an illustrative diagram showing an example of a length measurement task.

FIG. 9 is an illustrative diagram showing an example of a wire collection task.

FIG. 10 is an illustrative diagram showing an example of a partial bundling task.

FIG. 11 is a flowchart showing an example of a wire bundling task performed by a control unit.

FIG. 12 is a flowchart showing an example of bundle processing for branched portions.

### DESCRIPTION OF EMBODIMENTS

### Description of Embodiments of Disclosure

First, embodiments of the present disclosure will be listed and described.

A method for manufacturing a wire harness according to the present disclosure is as follows.

(1) A method for manufacturing a wire harness by bundling a wiring body for the wire harness, the wiring body being in a state before a branch is formed, the method including: (a) a process of arranging a plurality of terminal portions of the wiring body side by side in a terminal holding jig; (b) a process of transferring, out of the plurality of terminal portions, one terminal portion branching from one branch point, from the terminal holding jig to a terminal holding portion of a length adjusting mechanism; (c) a process of moving the terminal holding portion in a predetermined draw-out direction with a holding portion moving portion of the length adjusting mechanism, and measuring a length from the one terminal portion to a position of the one branch point; and (d) a process of bundling the wires that extend from all the terminal portions branching from the one branch point at the one branch point, in a state in which the processes (b) and (c) have been performed for all the terminal portions branching from the one branch point. In this manner, measurement of the length from the terminal portion to the branch point can be automated. In this case, the device used for measuring the length can be a simple device that moves in the draw-out direction.

(2) In the process (c), the terminal holding portion may also grip the wires in the terminal portion. In this manner, when the terminal holding portion is moved in the draw-out direction to move the terminal portion, a force which causes the end portions of the wires to come off from the connector is unlikely to act on the end portion of the wires.

(3) Further, a manufacturing device for a wire harness according to the present disclosure is a device for manufacturing a wire harness by bundling a wiring body for the wire harness, the wiring body being in a state before a branch is formed, the device including: a length adjusting mechanism that includes a terminal holding portion for holding one terminal portion of the wiring body and a holding portion moving portion that can reciprocate the terminal holding portion in a predetermined draw-out direction, and the length adjusting mechanism is configured to measure a length from a terminal portion to a position of a branch point by moving the terminal holding portion with the holding portion moving portion in the draw-out direction in a state in which the terminal portion is held by the terminal holding portion. In this manner, the length from the terminal portion to the branch point can be measured by the length-adjusting mechanism. The branch point can be easily specified and readily bundled. Since the holding portion moving portion moves the terminal holding portion in a predetermined draw-out direction, the configuration of the length adjusting mechanism can be simple.

(4) A configuration is also possible in which a transfer mechanism for removing one of a plurality of terminal portions of the wiring body from a terminal holding jig in which the terminal portions are arranged side by side and transferring that terminal portion to the terminal holding portion is provided. In this manner, the task of transferring the terminal portion from the terminal holding jig to the terminal holding portion can be automated.

(5) A configuration is also possible in which a tape winding mechanism that can bundle wires that extend from the terminal portion that is moved by the length adjusting mechanism is provided. In this manner, the task for winding tape around the wire can be automated.

(6) A configuration is also possible in which a branched line collecting portion configured to collect the wires whose lengths have been adjusted to all the terminal portions that are branched from one branch point is further provided. In this manner, the task for bundling the branch can be automated.

(7) A configuration is also possible in which the terminal holding portion includes a chuck for gripping the wires that extend from a connector at the terminal portion. In this manner, when the terminal holding portion is moved by the holding portion moving portion, a force which causes the wires to come off from the connector is unlikely to act.

### Description of Embodiments of Disclosure

A specific example of a manufacturing method and a manufacturing device for a wire harness according to the present disclosure will be illustrated below with reference to the drawing as follows. The present disclosure is not limited to the embodiments disclosed herein, but defined by the claims, and intended to include all modifications within the meaning and the scope equivalent thereof.

### Embodiment

Hereinafter, a manufacturing method and a manufacturing device for a wire harness according to an embodiment will be illustrated.

### Wire Harness

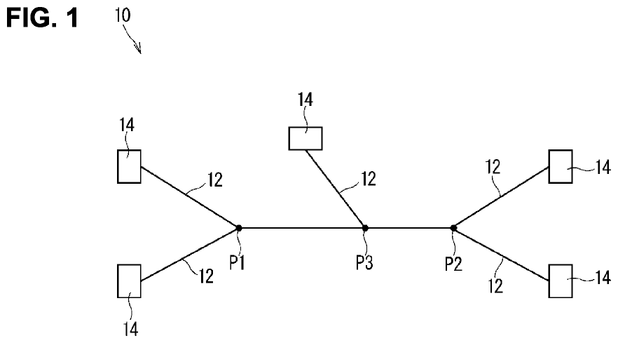

First, a wire harness to be manufactured will be described. FIG. 1 is a plan view showing a wire harness 10.

The wire harness 10 shown in FIG. 1 is formed in a shape in which a plurality of wires 12 are branched at branch points P1, P2, and P3. The plurality of wires 12 keep their branched shape by bundling portions of the plurality of wires 12 that correspond to the branch points P1, P2, and P3 with a binding member such as adhesive tape, for example.

Connectors 14 are provided at end portions of the plurality of wires 12. The connectors 14 are formed by, for example, housing the end portions of the wires 12 in cavities (not shown) respectively formed at connector housings. Usually, terminals (not shown) are provided at end portions of the wires 12. In the connectors 14, terminals are provided that can be connected to terminals of their counterpart connectors.

In the present disclosure, the wire harness 10 in a state before the branched portions are bundled is referred to as a “wiring body 11”. The wiring body 11 is in a state after a circuit formation process and before an assembly process. In the wiring body 11, although the end portions of the plurality of wires 12 are connected to the connectors 14, the branched portions of the plurality of wires 12 are not yet bundled. The wiring body 11 is subjected to the assembly process, and thereby the wire harness 10 is formed.

Further, in the present disclosure, the connectors 14 and portions of the wires 12 extending from the connectors 14 that are near the connectors 14 are referred to as “terminal portions 16”.

### Manufacturing Device for Wire Harness

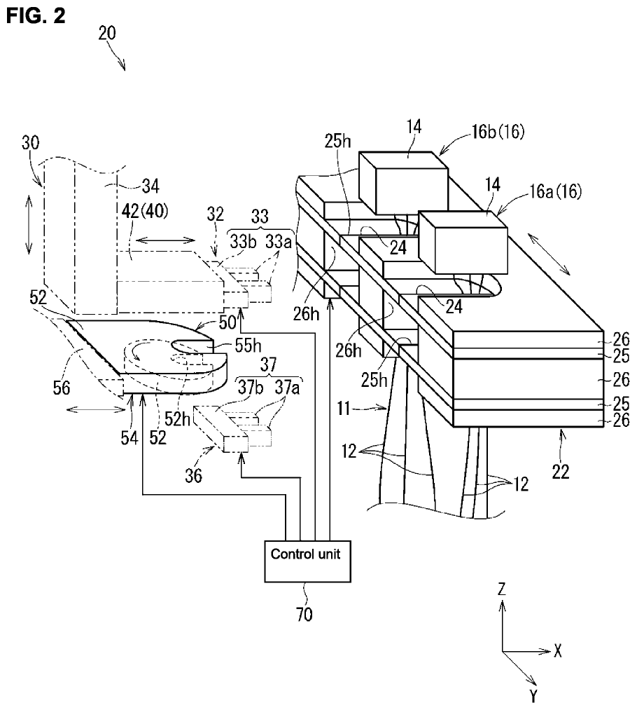

Next, the manufacturing device for a wire harness according to the present embodiment will be described. FIG. 2 is a perspective view showing a manufacturing device 20 of the wire harness according to the embodiment (hereinafter simply referred to as “manufacturing device 20”).

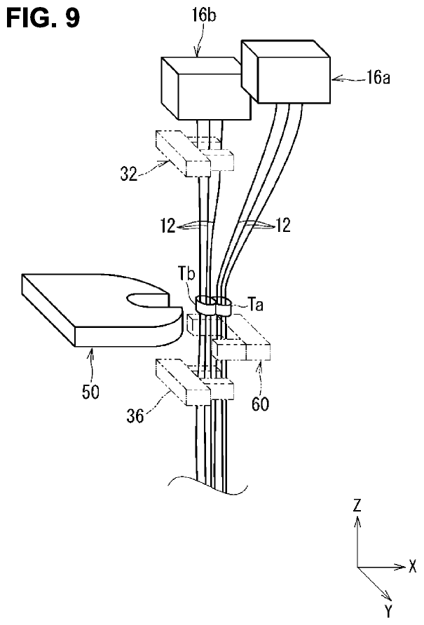

The manufacturing device 20 is a device for manufacturing a wire harness 10 by bundling a wiring body 11, which is the wire harness 10 in a state where branches have not yet been formed. The manufacturing device 20 is provided with a terminal holding jig 22, a length adjusting mechanism 30, a transfer mechanism 40, and a tape winding mechanism 50. The manufacturing device 20 is further provided with a wire collection mechanism 60 (see FIG. 9).

The terminal holding jig 22 includes a plurality of holding portions 24. The plurality of holding portions 24 are arranged side by side. The holding portions 24 can hold the respective terminal portions 16. With this configuration, the plurality of terminal portions 16 are held in the state where they are arranged side by side by the terminal holding jig 22. In the example shown in FIG. 2, the holding portions 24 are configured to hold the wires 12 extending from the connectors 14.

Specifically, the terminal holding jig 22 includes elastic plates 25 and supporting plates 26. The elastic plates 25 and the supporting plates 26 are elongated in one direction. The elastic plates 25 are made of an elastic material such as rubber. The supporting plates 26 have a higher rigidity than the elastic plates 25. The supporting plates 26 sandwich to support the elastic plates 25. A plurality of slits 25h are formed in the elastic plates 25. The slits 25h extend from one edge portion to the other edge portion of the elastic plates 25. The plurality of slits 25h are arranged side by side in a longitudinal direction of the elastic plates 25. A plurality of recesses 26h are formed in the supporting plates 26. The recesses 26h reaches from one edge portion to the other edge portion of the supporting plates 26. The recesses 26h are formed at positions corresponding to the slits 25h. The recesses 26h are formed such that regions of the elastic plates 25 where the slits 25h are formed are exposed. The terminal portions 16 are held by the holding portions 24 by inserting the wires 12 extending from the connectors 14 into the slits 25h. In other words, the portions of the terminal holding jig 22 where the slits 25h are formed are the holding portions 24.

Of course, the configuration of the holding portions 24 is not limited to that described above. For example, the holding portions may also be configured to hold connector housings. The holding portions may also be formed in a box-like shape that can house the connector housings.

The terminal holding jig 22 can be moved by a holding tool moving portion (not shown). The direction in which the terminal holding jig 22 is moved is the direction along which the plurality of terminal portions 16 are arranged. Due to the terminal holding jig 22 being moved with the holding tool moving portion, a predetermined holding portion 24 of the plurality of holding portions 24 can be positioned at a position corresponding to the length adjusting mechanism 30.

Hereinafter, in some cases, the direction in which the wires 12 extending from the connectors 14 are inserted into the slits 25h is referred to as “x direction”, the direction in which the terminal holding jig 22 moves is referred to as “y direction”, and the direction orthogonal to the x and y directions is referred to as “z direction”. Here, the z direction is the vertical direction. However, it is also possible that the z direction is the horizontal direction, and the x and y directions are the vertical directions.

The length adjusting mechanism 30 is a portion for measuring the length from one terminal portion 16 to a branch point. The length adjusting mechanism 30 includes a terminal holding portion 32 and a holding portion moving portion 34. Here, the length adjusting mechanism 30 further includes a middle holding portion 36.

The terminal holding portion 32 holds the terminal portions 16. Here, the terminal holding portion 32 includes a chuck 33. The chuck 33 holds the wires 12 extending from the connector 14. The chuck 33 includes a plurality of gripping claws 33a and an open/close drive portion 33b. The plurality of gripping claws 33a are configured to hold the wires 12 extending from the connector 14. The open/close drive portion 33b drives the open/close movement of the plurality of gripping claws 33a. There is no particular limitation to the drive source of the open/close drive portion 33b, which may be electricity, air pressure, or the like.

The terminal holding portion 32 may also include a connector supporting portion (not shown). The connector supporting portion may also be configured to support the connector 14 in a state where the chuck 33 grips the wires 12 extending from the connector 14. In this manner, a case in which the connector 14 hangs down from the chuck 33 can be suppressed. The connector supporting portion may also be attached to the chuck 33, for example.

Of course, the configuration of the terminal holding portion 32 is not limited to that described above. The terminal holding portion 32 may also be a connector holding portion for holding a connector, for example.

The holding portion moving portion 34 reciprocates the terminal holding portion 32 along a predetermined draw-out direction. In the example shown in FIG. 2, the draw-out direction is the z direction. The holding portion moving portion 34 is, for example, an actuator that operates linearly, such as a linear moving cylinder, a ball screw, or a linear actuator. The holding portion moving portion 34 can place the terminal holding portion 32 at any point between a start point and an end point along the draw-out direction. In this manner, the terminal holding portion 32 can be positioned at any point in an operation region of the holding portion moving portion 34, and the length from the terminal portion 16 to the branch point can be measured.

When the terminal holding portion 32 is moved by the holding portion moving portion 34, the middle holding portion 36 holds a middle portion of the wires 12 with respect to the terminal portion 16. When the terminal holding portion 32 is moved by the holding portion moving portion 34 in a state where the middle holding portion 36 holds the wires 12, the middle holding portion 36 holds the wires 12 slidably with respect to the middle holding portion 36. In this manner, the wires 12 are drawn out from the middle holding portion 36 while being aligned by the middle holding portion 36. In the example shown in FIG. 2, the middle holding portion 36 includes the chuck 37. The chuck 37 includes a plurality of gripping claws 37a and an open/close drive portion 37b. The plurality of gripping claws 37a is configured to grip the wires 12. The open/close drive portion 37b drives the open/close movement of the plurality of gripping claws 37a. There is no particular limitation to the drive source of the open/close drive portion 37b, which may be electricity, air pressure, or the like. Because the gripping force of the chuck 37 is weaker than that of the chuck 33, the wires 12 can slide therebetween. In other words, the chuck 33 can grip the wires 12 with a force that is stronger than that of the chuck 37 such that the wires 12 do not slide therebetween. Of course, the middle holding portion 36 does not need to include the chuck 37. For example, the middle holding portion 36 may also be formed by providing the elastic plate 25 with the slit 25h, like the holding portion 24.

The holding portion moving portion 34 can prevent movement of the middle holding portion 36. That is, the middle holding portion 36 and the holding portion moving portion 34 are provided separately. For this reason, the terminal holding portion 32 approaches/moves away from the middle holding portion 36.

The transfer mechanism 40 removes one of the terminal portions 16 from the terminal holding jig 22 and transfers that terminal portion 16 to the terminal holding portion 32. Here, the transfer mechanism 40 is provided such that the terminal holding portion 32 can directly hold the terminal portion 16 held by the terminal holding jig 22. Specifically, when the aforementioned holding portion moving portion 34 is considered as a first holding portion moving portion 34, the first holding portion moving portion 34 is used as the transfer mechanism 40. Further, the transfer mechanism 40 is provided with a second holding portion moving portion 42 separately from the first holding portion moving portion 34.

The first holding portion moving portion 34 is configured to move the terminal holding portion 32 to a position facing one of the holding portions 24 of the terminal holding jig 22. The second holding portion moving portion 42 moves the terminal holding portion 32 in the direction that intersects a direction in which the first holding portion moving portion 34 moves. In the example shown in FIG. 2, the second holding portion moving portion 42 moves the terminal holding portion 32 in the x direction. The second holding portion moving portion 42 can be moved by the first holding portion moving portion 34 along with the terminal holding portion 32.

The first holding portion moving portion 34 moves the second holding portion moving portion 42 and the terminal holding portion 32 to a position facing one of the holding portions 24 of the terminal holding jig 22. In this state, the second holding portion moving portion 42 moves the terminal holding portion 32 to approach a location at which the terminal holding portion 32 can directly hold the terminal portion 16 held by that holding portion 24. Then, the terminal holding portion 32 directly holds the terminal portion 16 held by that holding portion 24. In this state, the second holding portion moving portion 42 moves the terminal holding portion 32 away from the terminal holding jig 22. In this manner, the terminal portion 16 has been transferred from the terminal holding jig 22 to the terminal holding portion 32.

Note that the transfer mechanism 40 need not necessarily be provided such that the terminal holding portion 32 can directly hold the terminal portion 16 held by the terminal holding jig 22. The transfer mechanism 40 may also be provided such that, for example, a mechanism separate from the terminal holding portion 32 removes the terminal portion 16 from the terminal holding jig 22 and conveys the terminal portion 16 to the terminal holding portion 32. In this case, the transfer mechanism 40 may also include a transferred terminal holding portion that is provided separately from the terminal holding portion 32 and a transfer holding portion moving portion for moving the transferred terminal holding portion. The transferred terminal holding portion may be, for example, a chuck or the like. The transfer holding portion moving portion reciprocates the transferred terminal holding portion between a position corresponding to the terminal holding jig 22 and a position corresponding to the terminal holding portion 32.

The tape winding mechanism 50 is configured to bundle the wires 12 extending from the terminal portion 16 that is moved by the length adjusting mechanism 30. There is no particular limitation to the tape winding mechanism 50, as long as it can bundle the wires 12. Here, the tape winding mechanism 50 can approach and bundle the wires 12 from a state where it is located on the side of the wires 12. Also, the tape winding mechanism 50 can retract to the side of the wires 12 after bundling the wires 12. In the example shown in FIG. 2, the tape winding mechanism 50 includes a rotating body 52, a base 54, and a base moving portion 56.

The rotating body 52 is formed in a shape in which a round plate is provided with a recessed groove 52h. The recessed groove 52h is formed such that a portion along the circumferential direction of the round plate is recessed toward the center thereof. The wires 12 are inserted from an opening of the recessed groove 52h toward the bottom thereof. The wires 12 are located on the bottom side of the recessed groove 52h and are thereby located in the center of the rotating body 52. In a state where the wires 12 to which one end portion of adhesive tape is attached are located in the center of the rotating body 52, rotation of the rotating body 52 winds the other end portion of the adhesive tape around the wires 12.

The base 54 rotatably supports the rotating body 52. The base 54 includes a base plate 55 and a plurality of gears (not shown), for example. A recessed groove 55h that corresponds to the recessed groove 52h of the rotating body 52 is formed in the base plate 55. The plurality of gears are provided at intervals therebetween along the circumferential direction of the rotating body 52. The plurality of gears are rotatably supported by the base plate 55. Due to the plurality of gears engaging with the gears formed on the outer circumferential surface of the rotating body 52, the rotating body 52 is rotatably supported by the base 54. The gears are rotated by a driving unit (not shown). In this manner, the rotating body 52 rotates.

The base moving portion 56 moves the base 54 along a predetermined base movement direction. The base movement direction is a direction intersecting (here, orthogonal to) the above draw-out direction. In this manner, the rotating body 52 can approach the wires 12 from the side of the wires 12, and retract to the side of the wires 12 after bundling the wires 12. In the example shown in FIG. 2, the direction in which the base 54 moves is the x direction, but this direction may also be the y direction.

The tape winding mechanism 50 is located between the start point and the end point of the movement of the terminal holding portion 32 along the draw-out direction, and does not move in the draw-out direction. In other words, the base moving portion 56 does not move the base 54 in the z direction. The base moving portion 56 is, for example, an actuator that operates linearly, such as a linear moving cylinder, a ball screw, or a linear actuator. Here, since the terminal holding portion 32 moves in the draw-out direction, any portion of the wires 12 extending out from the terminal portion 16 can be bundled by the tape winding mechanism 50. Due to the terminal holding portion 32 moving in the draw-out direction through the holding portion moving portion 34, a portion of the wires 12 that needs to be bundled is arranged in front of the tape winding mechanism 50.

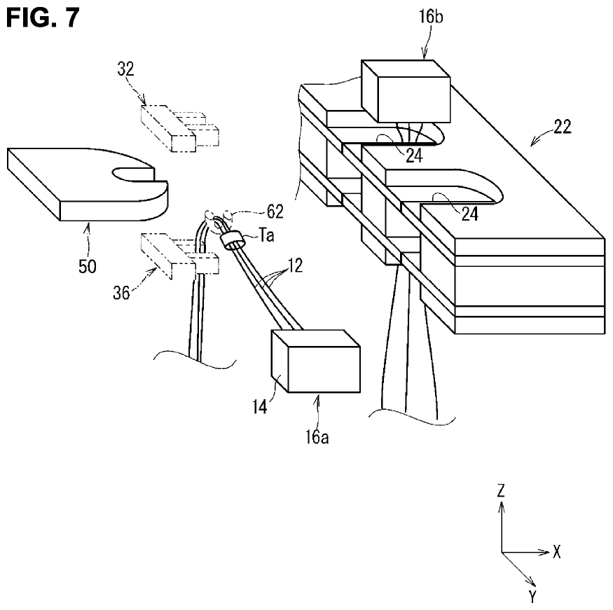

A wire collection mechanism 60 collects the wires 12 whose length have been adjusted at all the terminals 16 that are branched from one branch point. When length adjustment is finished on one terminal portion 16 that is branched from one branch point, in order to perform length adjustment of the next terminal portion 16, the terminal portion 16 on which the length adjustment has been finished is transferred from the length adjusting mechanism 30 to a temporary holding portion 62 (see FIG. 7). When length adjustment has been finished for all the terminal portions 16 branched from the one branch point, the wire collection mechanism 60 collects the wires 12 that were subjected to length adjustment at all the terminal portions 16 branched from the one branch point. In this manner, the task of bundling the branches can be automated.

The operation of the units in the manufacturing device 20 is controlled by the control unit 70. The control unit 70 controls the operation of the manufacturing device 20 based on task programs stored in advance. At this time, the control unit 70 controls the transfer mechanism 40 to perform a task of transferring the terminal portion 16 held by the terminal holding jig 22 to the terminal holding portion 32. The control unit 70 controls the length adjusting mechanism 30 to measure the length from the terminal portion 16 to the branch point. Here, the distance from the terminal portion 16 to the branch point is stored in the control unit 70 in advance. The control unit 70 controls the holding portion moving portion 34 to move the terminal holding portion 32 that holds the terminal portion 16 by a predetermined distance stored in advance. The control unit 70 controls the tape winding mechanism 50 to bundle the branch point.

The control unit 70 is formed by a computer formed by a CPU, a ROM, a RAM, an external storage device, and the like that are connected to each other via a bus line. The ROM stores basic programs and the like, and the RAM is provided as a working region used when the CPU performs processing according to a predetermined procedure. The external storage device is formed by a non-volatile storage device such as a flash memory, a hard disk device, or the like. An OS (operation system), task instruction data, a processing program, and the like are stored in the external storage device. The task instruction data includes information such as which terminal portion 16 to move and by what distance, what kind of processing to perform on which terminal portion 16, and which terminal portion 16 to process first. The processing program includes a program for operating the holding portion moving portion 34, a program for operating the transfer mechanism 40, a program for operating the tape winding mechanism 50, a program for operating the wire collection mechanism 60, and the like. Due to the CPU serving as a main control unit performing computation processing according to a procedure described in the processing program, the operation of the manufacturing device 20 is controlled. A control signal is given from the control unit 70 to the manufacturing device 20, and the operation of the manufacturing device 20 is controlled, for example.

### Manufacturing Method for a Wire Harness

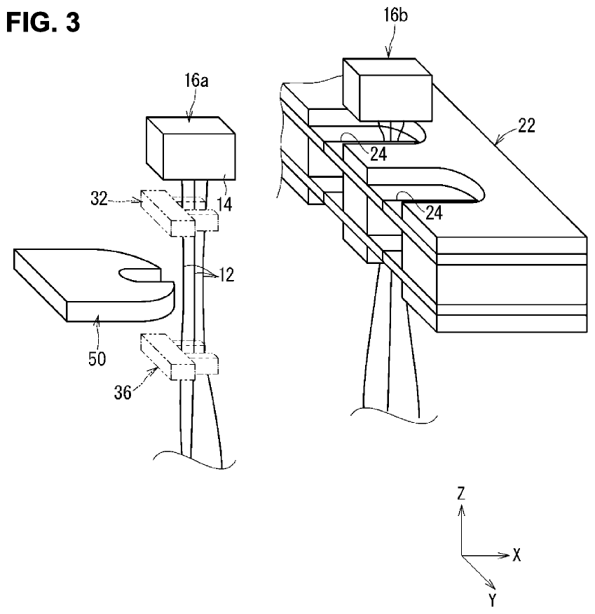

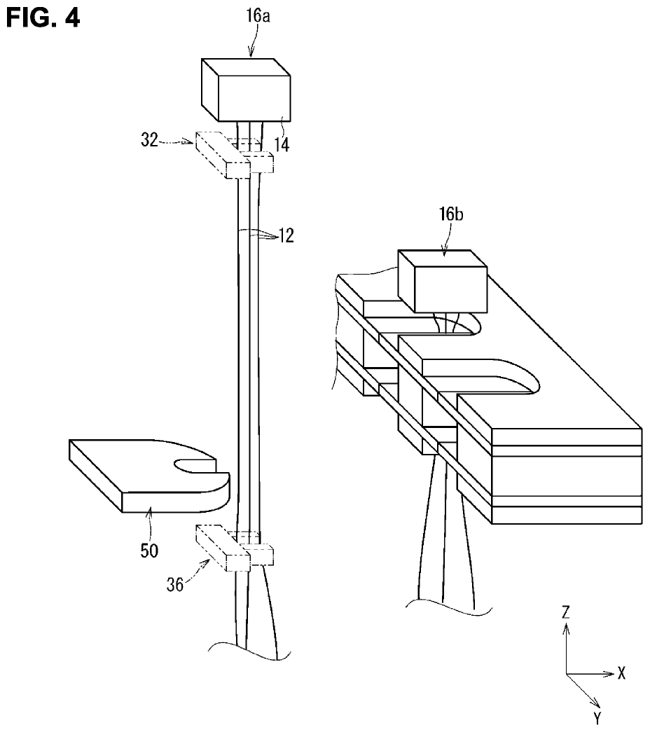

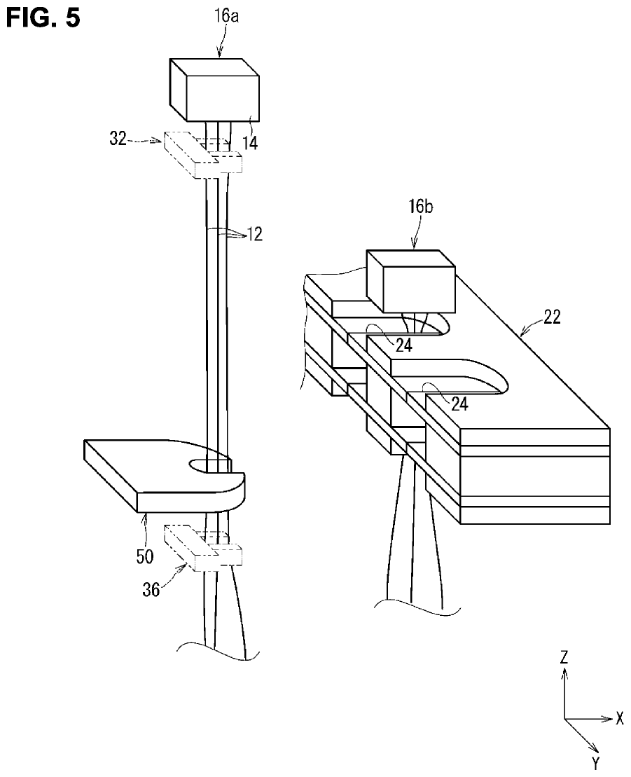

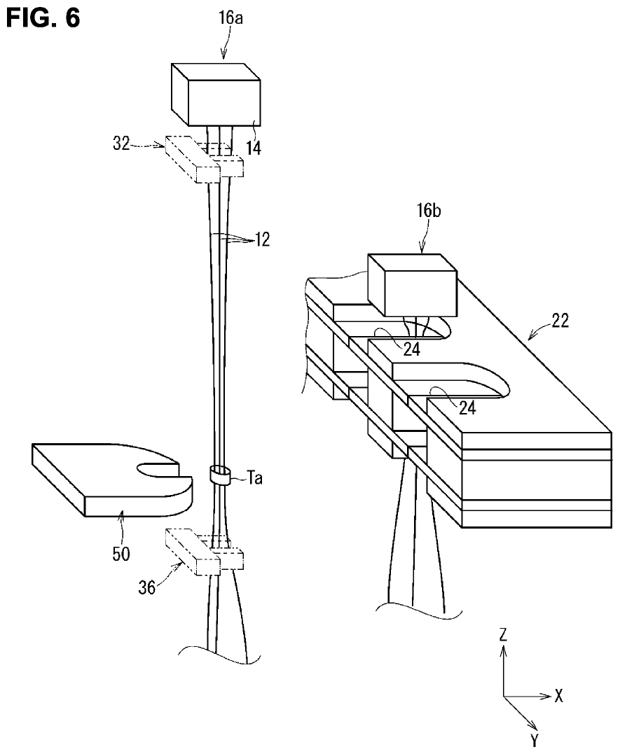

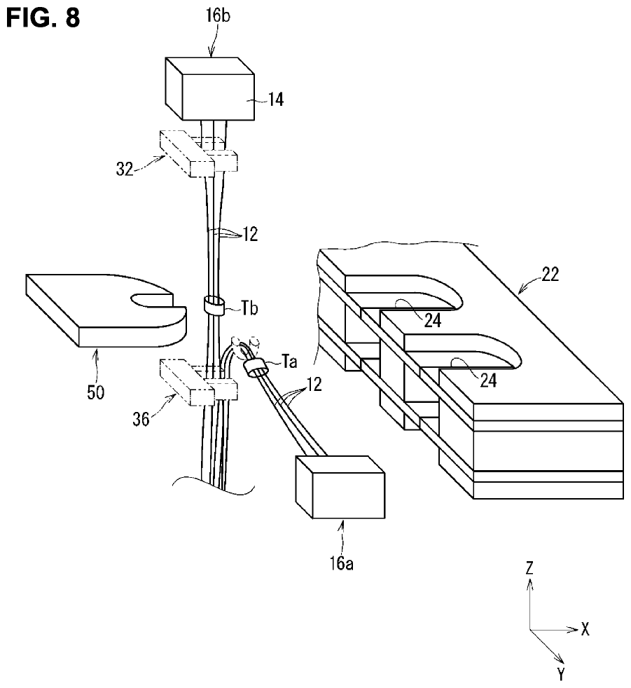

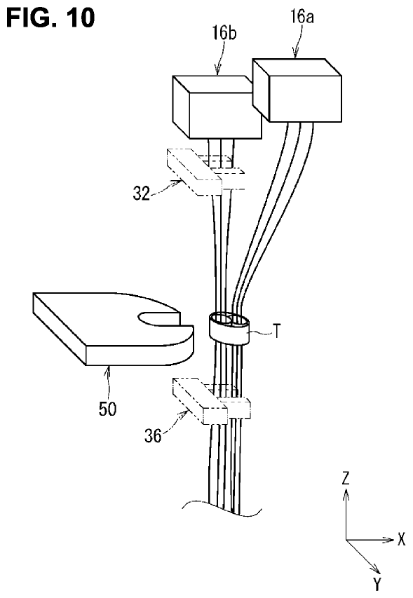

Next, a method for manufacturing a wire harness according to the embodiment will be described. FIG. 3 is an illustrative diagram showing an example of a transfer task. FIG. 4 is an illustrative diagram showing an example of a length measurement task. FIG. 5 and FIG. 6 are illustrative diagrams showing an example of a partial bundling task. FIG. 7 is an illustrative diagram showing an example of a temporary holding task. FIG. 8 is an illustrative diagram showing an example of a length measurement task. FIG. 9 is an illustrative diagram showing an example of a wire collection task. And FIG. 10 is an illustrative diagram showing an example of a partial bundling task.

The manufacturing method for a wire harness is a method for manufacturing a wire harness 10 by bundling the wiring body 11, which is the wire harness 10 in the state before any branches are formed. Here, a method for manufacturing a wire harness 10 using the above manufacturing device 20 will be described as an example. Hereinafter, a description will be given using an example in which the wiring body 11 is bundled at a branch point P1.

First, the plurality of terminal portions 16 of the wiring body 11 are prepared and arranged side by side in the terminal holding jig 22 (process (a)). The terminal holding jig 22 that holds the plurality of terminal portions 16 in a state in which they are arranged side by side is located at a predetermined position with respect to the manufacturing device 20. FIG. 2 shows an example of the state when the process (a) is finished.

The task of causing the holding portions 24 of the terminal holding jig 22 to hold the terminal portions 16 and arranging the plurality of terminal portions 16 side by side may be performed manually or automatically. There is no particular limitation to the position at which the task of holding the terminal portions 16 with the holding portions 24 of the terminal holding jig 22 is performed. The plurality of terminal portions 16 may also be held by the terminal holding jig 22 in a state where the terminal holding jig 22 is located at a predetermined position with respect to the manufacturing device 20, for example. Alternatively, the plurality of terminal portions 16 may also be held by the terminal holding jig 22 in a state where the terminal holding jig 22 is located at another task station, that is, where the terminal holding jig 22 is located at a location spaced apart from a predetermined location with respect to the manufacturing device 20, for example. In this case, the terminal holding jig 22 may be moved to the predetermined position with respect to the manufacturing device 20 manually or automatically.

Next, one of the plurality of terminal portions 16 that branches from one branch point P1 is transferred from the terminal holding jig 22 to the terminal holding portion 32 (process (b)). Here, first, the transfer mechanism 40 transfers a terminal portion 16a, out of the terminal portion 16a and the terminal portion 16b that branch from the one branch point P1, from the terminal holding jig 22 to the terminal holding portion 32. Specifically, the control unit 70 operates the holding tool moving portion to move the terminal holding jig 22 such that the terminal portion 16a is located at a predetermined position for performing transfer in a state where the terminal holding jig 22 is located at a predetermined position with respect to the manufacturing device 20. In this state, the control unit 70 operates the transfer mechanism 40 to move the terminal holding portion 32 to approach the terminal holding jig 22 such that the terminal holding portion 32 is located at a position at which the terminal holding portion 32 can hold the terminal position 16a. The control unit 70 operates the terminal holding portion 32 to hold the terminal portion 16a in a state where the terminal holding portion 32 is located at a position at which the terminal holding portion 32 can hold the terminal portion 16. The control unit 70 operates the transfer mechanism 40 to move the terminal holding portion 32 away from the terminal holding jig 22 such that the terminal holding portion 32 is located at an initial position for length measurement in the state where the terminal holding portion 32 holds the terminal portion 16a. Accordingly, the terminal portion 16a has been removed from the terminal holding jig 22 and transferred to the terminal holding portion 32. FIG. 3 shows an example of the state where the process (b) is finished.

Note that, when the terminal holding portion 32 is located at the initial position for length measurement, the wires 12 extending from the terminal portion 16a are held by the middle holding portion 36. Specifically, when the terminal holding portion 32 moves toward the initial position for length measurement, the wires 12 extending from the terminal portion 16a are drawn out to a position at which the wires 12 can be held by the middle holding portion. In this state, the control unit 70 drives the chuck 37, and the chuck 37 holds the wires 12.

Next, the control unit 70 moves the terminal holding portion 32 in a predetermined draw-out direction using the holding portion moving portion 34 and measures the length from the one terminal portion 16 to the one branch point P1 (process (c)). Here, in the state in which the terminal holding portion 32 is located at the initial position for length measurement, the control unit 70 operates the holding portion moving portion 34 to move the terminal holding portion 32 in a predetermined draw-out direction. At this time, the control unit 70 obtains the distance by which the terminal holding portion 32 that holds the terminal portion 16a is moved, by referring to the task instruction data. FIG. 4 shows an example of the state where the process (c) is finished.

Here, when measuring the length of the terminal portion 16a, the wires 12 of the terminal portion 16a are bundled. Specifically, in the state after length measurement shown in FIG. 4 is performed, as shown in FIG. 5, the control unit 70 operates the base moving portion 56 and moves the rotating body 52 towards the wires 12. Then, in the state where the wires 12 are accommodated in the recessed groove 52h, the control unit 70 drives the rotating body 52 to rotate and bundle the wires 12. After bundling of the wires 12 is finished, as shown in FIG. 6, the control unit 70 operates the base moving portion 56 and retracts the rotating body 52 from the wires 12. A partially bundled portion Ta is formed in the wires 12 extending from the terminal portion 16a.

Also, here, after measuring the length of the terminal portion 16a, as shown in FIG. 7, this terminal portion 16a is temporarily held at a location at which this terminal portion 16a does not interfere with the length measurement of the next terminal portion 16. A portion on the terminal portion 16 side with respect to the middle holding portion 36 is bent and held by the temporary holding portion 62.

When length measurement of the terminal portion 16a is finished, the process (b) and process (c) are also performed for the terminal portion 16b, and thereby length measurement of the terminal portion 16b is performed. Specifically, the control unit 70 operates the holding tool moving potion to move the holding portion 24 that holds the terminal portion 16b to a predetermined position for transfer. In this state, the control unit 70 operates the transfer mechanism 40 to transfer the terminal portion 16b from the terminal holding jig 22 to the terminal holding portion 32. Then, the control unit 70 operates the holding portion moving portion 34 and moves the terminal holding portion 32 in the draw-out direction. At this time, the control unit 70 obtains the distance by which the terminal portion 16b is moved, by referring to the task instruction data. In this manner, with respect to the terminal 16b as well, the length between the terminal portion 16b to the branch point P1 is measured. FIG. 8 shows the state where the length measurement on the terminal portion 16b is finished. Note that in the example shown in FIG. 8, the wires 12 extending from the terminal portion 16b are also bundled just like the wires 12 extending from the terminal portion 16a. Since the operation for bundling the wires 12 extending from the terminal portion 16b performed by the tape winding mechanism 50 is similar to the operation for bundling the wires 12 extending from the terminal portion 16a performed by the tape winding mechanism 50, the details thereof will not be described. A partially bundled portion Tb is formed on the wires 12 extending from the terminal portion 16b.

Next, in the state where processes (b) and (c) have been performed on all the terminal portions 16a and 16b branched from the one branch point P1, the plurality of wires 12 extending from all the terminal portions 16a and 16b branched from this branch point P1 are bundled at the branch point P1 (process (d)). Here, first, the control unit 70 operates the wire collection mechanism 60 and collects the wires 12 extending from the terminal portions 16a and 16b such that the wires 12 can be bundled. For example, the wire collection mechanism 60 collects portions (here, bundled portions) of the terminal portions 16a and 16b that correspond to the branch point P1, or regions near the portions, to a position that corresponds to the tape winding mechanism 50. Next, the control unit 70 operates the tape winding mechanism 50 and bundles the wires 12 extending from the terminal portions 16a and 16b into one bunch. Since the operation for bundling the wires 12 extending from the terminal portions 16a and 16b performed by the tape winding mechanism 50 is similar to the operation for bundling the wires 12 extending from the terminal portion 16a performed by the tape winding mechanism 50, the details thereof will not be described. A branch bundled portion T is formed on the wires 12 extending from the terminal portions 16a and 16b.

In the example shown in FIG. 10, the branch bundled portion T is provided at a position that corresponds to the partially bundled portions Ta and Tb. Of course, the branch bundled portion T may also be provided at a location spaced apart from the partially bundled portions Ta and Tb in the longitudinal direction of the wires 12.

As described above, the branch point P1 has been bundled and the branch has been formed. Due to the branch formation task being performed on the other branch points P2 and P3 as well, the branched shape is formed at the wiring body 11, and thus the wire harness 10 shown in FIG. 1 is formed. Note that, similar to the branch point P1, the branch formation task may also be performed on the other branch points P2 and P3 by the above manufacturing method and manufacturing device 20. The branch formation task may also be performed on the branch points P2 and P3 by a method other than the above manufacturing method and manufacturing device 20.

### Example of Overall Task Processing

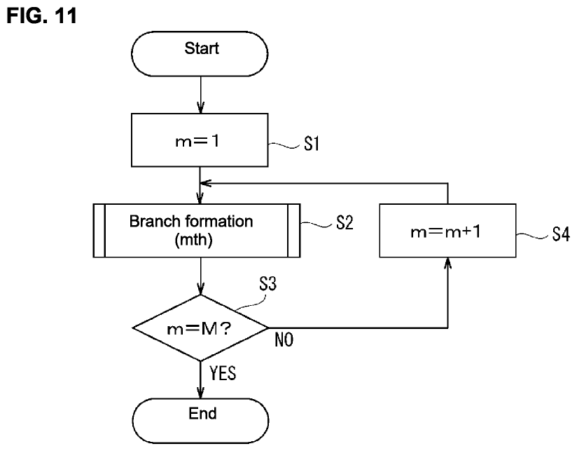

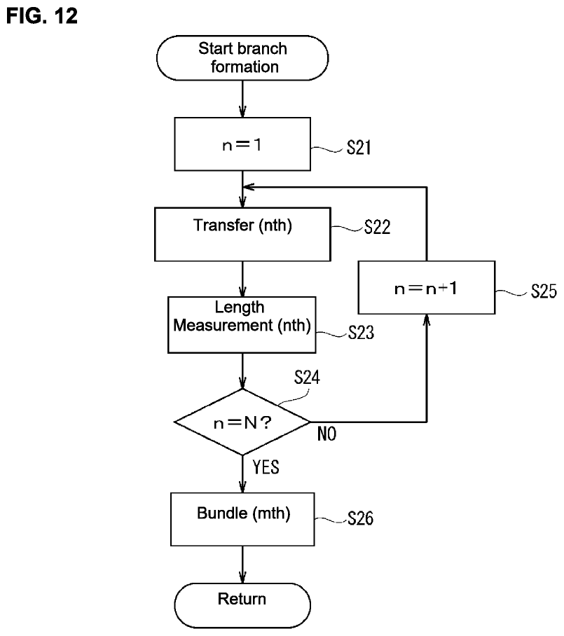

FIG. 11 is a flowchart showing an example of bundle processing for the wires 12 performed by the control unit 70. FIG. 12 is a flowchart showing an example of bundle processing for the branch points. It is assumed that, when performing bundle processing for the wires 12, as described above, the order for processing the branch points P1, P2, and P3, and the order for processing the terminal portions 16 of the branch points P1, P2, and P3 are specified. Also, it is assumed that the above process (a) has been finished.

First, in step S1, m=1 is set (initial setting).

Next, in step S2, the mth processing for forming the branch point is performed.

Specifically, first, in step S21, n=1 is set (initial setting).

Next, in step S22, the transfer task is performed. The control unit 70 gives an instruction to the manufacturing device 20 to transfer the nth terminal portion 16 at the mth branch point from the terminal holding jig 22 to the terminal holding portion 32. The transfer task of the terminal portion 16 is performed according to the above process (b).

In the next step S23, the length measurement task is performed. The control unit 70 gives an instruction to the manufacturing device 20 to measure the length of the nth terminal portion 16 at the mth branch point. The length measurement task of the terminal portion 16 is performed according to the above process (c).

In the next step S24, the control unit 70 determines whether n=N (total number of the terminal portions 16). If n=N is not satisfied, the length measurement task for all the terminal portions 16 at the mth branch point has not been finished, and thus, in step S25, n is incremented by 1 and the processing returns to step S22. If n=N is satisfied, the length measurement task of all the terminal portions 16 at the mth branch point has been finished, and thus the processing advances to step S26.

In step S26, the mth branch point is bundled. The task of bundling the branch point is performed according to the above process (d). By finishing step S26, step S2 regarding the formation processing of the mth branch point is finished.

In the next step S3, the control unit 70 determines whether m=M (total number of the branch point). If m=M is not satisfied, the formation task for all the branch points has not been finished, in step S4, m is incremented by 1, and therefore the processing returns to step S2. If m=M is satisfied, the formation task for all the branch points has ended, and therefore the processing ends.

Note that “all the branch points” mentioned here means all the branch points of the wire harness 10 at which the branch formation task using the above manufacturing method and the manufacturing device 20 is performed, and is not limited to all the branch points P1, P2, and P3 of the wire harness 10. In other words, the branch formation task using the above manufacturing method and the manufacturing device 20 need not necessarily be performed on all the branch points P1, P2, and P3 of the wire harness 10, and the branch formation task using the above manufacturing method and the manufacturing device 20 may also be performed on only a subset of the branch points.

### Effects, Etc.

According to the manufacturing method and manufacturing device 20 for a wire harness configured as above, the length from the terminal portion 16 to the branch point is measured by the length adjusting mechanism 30. In this manner, measurement of the length from the terminal portions 16 to the location of the branch point can be automated. Also, the branch points can be easily specified and bundled. Since the holding portion moving portion 34 moves the terminal holding portion 32 in a predetermined draw-out direction, the configuration of the length adjusting mechanism 30 can be simple. Also, with respect to the terminal portion 16 whose length was measured by the length adjusting mechanism 30, the need for conventional wiring task performed on the assembly board is eliminated.

Further, provision of the transfer mechanism 40 makes it possible to automate the task of transferring the terminal portions 16 from the terminal holding jig 22 to the terminal holding portion 32. Further, provision of the tape winding mechanism 50 makes it possible to automate the task of winding a tape around the wires 12.

Since the terminal holding portion 32 includes the chuck 33 for gripping the wires 12 extending from the connector 14 in the terminal portion 16, when the terminal holding portion 32 is moved by the holding portion moving portion 34, a force which causes the end portions of the wires 12 to come off from the connector 14 is not likely to act.

### Variations

In the embodiment, out of the above processes (a) to (d), the processes other than the process (c), namely, the process (a), process (b), and process (d) are also described as being automated, but this is not necessarily required. All or part of the above process (a), process (b), and process (d) may also be performed manually instead of being automated. In this case, the corresponding mechanism in the manufacturing device 20 may also be omitted. If the process (b) is manually performed, for example, the transfer mechanism 40 may be omitted from the manufacturing device 20. Also, if the process (d) is manually performed, for example, the tape winding mechanism 50 may be omitted from the manufacturing device 20.

Although the embodiment described that, in the process (c), the wires 12 extending from the terminal portion 16 are partially bundled at the time of length measurement, this is not necessarily required. If the wires 12 whose length has been measured are temporarily held such that the bundled point thereof can be bundled, for example, the wires 12 extending from the terminal portion 16 need not necessarily be partially bundled at the time of length measurement.

In addition, in the process (c), when the terminal portion 16 is being moved in order to be subjected to length measurement, the tape winding mechanism 50 may also bundle the wires 12 extending from this terminal portion 16. In this case, in the partially bundled portion, an adhesive tape is spirally wound around the wires 12 extending from the terminal portion 16. Also, in the process (c), when the terminal portion 16 is being moved in order to be subjected to length measurement, or after movement of the terminal portion 16 is finished and before the terminal portion is removed from the terminal holding portion 32, another component such as a tube or a clamp that forms the wire harness 10 may also be attached. The task of attaching the component may be performed manually or automatically. If the task of attaching the component is automated, the manufacturing device 20 may also be further provided with a component attaching mechanism for attaching a component such as the tube or the clamp.

Note that, the configurations described in the above embodiment and variations may be combined with each other as appropriate as long as no contradictions arise.

### LIST OF REFERENCE NUMERALS

10 Wire harness
11 Wiring body
12 Wire
14 Connector
16, 16a, 16b Terminal portion
20 Manufacturing device for wire harness
22 Terminal holding jig
24 Holding portion
25 Elastic plate
25h Slit
26 Supporting plate
26h Recessed groove
30 Length adjusting mechanism
32 Terminal holding portion
33 Chuck
33a Gripping claw
33b Open/close drive portion
34 Holding portion moving portion (first holding portion moving portion)
36 Middle holding portion
37 Chuck
37a Gripping claw
37b Open/close drive portion
40 Transfer mechanism
42 Second holding portion moving portion
50 Tape winding mechanism
52 Rotating body
52h Recessed groove
54 Base
55 Base plate
55h Recessed groove
56 Base moving portion
60 Wire collection mechanism
62 Temporary holding portion
70 Control unit
P1, P2, P3 Branch point
Ta, Tb Partially bundled portion
T Branch bundling portion

1. A method for manufacturing a wire harness by bundling a wiring body for the wire harness, the wiring body being in a state before a branch is formed, the method comprising:
arranging a plurality of terminal portions of the wiring body side by side in a terminal holding jig;
transferring, out of the plurality of terminal portions, one terminal portion branching from one branch point, from the terminal holding jig to a terminal holding portion of a length adjusting mechanism;
moving the terminal holding portion in a predetermined draw-out direction with a holding portion moving portion of the length adjusting mechanism, and measuring a length from the one terminal portion to a position of the one branch point; and
bundling wires that extend from all the terminal portions branching from the one branch point at the one branch point, after the transferring one terminal portion and the moving the terminal holding portion have been performed for all the terminal portions branching from the one branch point.

2. The method for manufacturing the wire harness according to claim 1,
wherein, in the moving the terminal holding portion, the terminal holding portion grips the wires in the terminal portion.

3. A device for manufacturing a wire harness by bundling a wiring body for the wire harness, the wiring body being in a state before a branch is formed, the device comprising:
a length adjusting mechanism that includes a terminal holding portion for holding one terminal portion of the wiring body and a holding portion moving portion that can reciprocate the terminal holding portion in a predetermined draw-out direction,
wherein the length adjusting mechanism is configured to measure a length from a terminal portion to a position of a branch point by moving the terminal holding portion with the holding portion moving portion in the draw-out direction in a state in which the terminal portion is held by the terminal holding portion.

4. The device for manufacturing a wire harness according to claim 3, further comprising:
a transfer mechanism for removing one of a plurality of terminal portions of the wiring body from a terminal holding jig in which the terminal portions are arranged side by side and transferring that terminal portion to the terminal holding portion.

5. The device for manufacturing a wire harness according to claim 3, further comprising:
a tape winding mechanism that can bundle wires that extend from the terminal portion that is moved by the length adjusting mechanism.

6. The device for manufacturing a wire harness according to claim 5, further comprising:
a branched line collecting portion configured to collect the wires whose lengths have been adjusted to all the terminal portions that are branched from one branch point.

7. The device for manufacturing a wire harness according to claim 3,
wherein the terminal holding portion includes a chuck for gripping wires that extend from a connector at the terminal portion.
